(19) United States
(12) Patent Application Publication
(10) Pub. No.: US 2005/0071471 A1
(43) Pub. Date: Mar. 31, 2005

(54) Automatic bandwidth control for file servers with a variable priority client base

(75) Inventor: Leonel Saenz III, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/674,978

(22) Filed: Sep. 30, 2003

(51) Int. Cl. G06F 15/173

(52) U.S. Cl. 709/226

(57) ABSTRACT

A server automatically allocates all bandwidth in proportion to current users' priorities, then continues to track the rate at which information is actually sent to users, which reflects the current connections between the server and the users. When any client is not utilizing the bandwidth allotted them, the allocation is reduced to the actual usage and unused bandwidth is redistributed, in the same ratio as the initial allocation of bandwidth, to any clients that are using all allocated bandwidth. The server continues to monitor usage and to correct allocations frequently. Additionally, a client whose time has been cut can incrementally regain their allocations by taking bandwidth away from users who have gained thereby. Thus, a decreased allocation can be recovered if conditions improve. This scheme provides that the server will be optimally used and maximally efficient.

### BACKGROUND OF THE INVENTION

1. Technical Field

This application relates to software control of the percentage of output time allocated to clients by a file server. More specifically, this application relates to dynamically adjusting the allocations to users according to the conflicting traffic on the Internet.

2. Description of Related Art

An internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies that must interact with virtually all segments of society such as the Internal Revenue Service and secretaries of state. These agencies can reduce operating costs by providing informational guides and/or searchable databases of public records online.

Because of the ever increasing numbers of users active on the Internet, it become increasingly important to prioritize communications so that availability can be optimized. To understand the problems, one must understand something of how the Internet works.

As mentioned above, the Internet uses the TCP/IP suite of protocols. These protocols dictate that data to be transmitted is packaged in packets of a given size, with information appended regarding the origination and destination points. These packets are then forwarded from one gateway on the Internet to the next, until they reach their destination. To ensure that the information is received, the sender will transmit one packet, then wait for confirmation that the packet has been received before sending another packet. If a confirmation is not received within a given time, the sender will retransmit the last packet.

A gateway can receive packets both from computers connected directly to it and also from other gateways. The gateway must therefore prioritize the order in which the packets are forwarded. Numerous prioritizing schemes can be employed, one exemplary one being disclosed in U.S. Pat. No. 6,385,169 to Wang, which is hereby incorporated by reference. Whatever prioritizing scheme is used, it will generally be implemented in the hardware, with information being supplied to the gateways regarding the priority of given users. Given the variable load and variable priorities on a gateway at any given time, a stream of information flowing from a sender to a receiver will not generally move at a steady rate. Instead, the rate will constantly vary, depending on the number of active users, their respective priorities, the amount of information being transmitted, and the particular algorithms utilized to determine when they are passed along.

In the existing art, a business can provide a server that offers an online service to a number of clients, e.g., a searchable database that is available only to registered customers. Such businesses often have their own allocation system for transmission to their customers, but the variability of the speed of transmissions can lower the efficiency of the server. A very simple example can demonstrate the problem. A server currently has four customers, A, B, C, and D, receiving data from the server. Customers A, B, and C have equal priority, while Customer D, has a higher priority and is allocated twice the time of the other three customers. The server will allocate 20% of the available transmission time to each of Customers A, B, and C and twice that, or 40%, of the available time to Customer D. The server will then attempt to transmit to the customers in this ratio, but may not be able to do so. If, for example, the gateways between the server and Customer D are experiencing a heavy load, the server must still wait for confirmation of each packet before sending the next and may not be able to keep the rate as high as desired. Because the server maintains fixed allocations, the server then has transmission time that it has allocated, but which is not being used. Thus, the server is under-utilized.

It would be advantageous to have a means by which the allocated but unused time could be utilized and the server made more efficient thereby.

### SUMMARY OF THE INVENTION

The present invention provides a software method, apparatus, and computer instruction in which a server automatically allocates bandwidth in proportion to the client's priority, ensuring that all available bandwidth is allocated to the current users. In addition, the server also tracks the rate at which the server is actually sending information to each of the clients, reflecting the current connections between the server and the clients. When any client is not utilizing the bandwidth allotted to that client, the allocation is reduced to the amount the client is actually using. Unused bandwidth is redistributed to any clients that are using all the bandwidth allocated. The unused bandwidth will be redistributed in the same ratio as the initial allocation of bandwidth. The server continues to monitor usage and to correct the allocations frequently. Additionally, a client whose time has been cut can have their allocations increased incrementally, by taking bandwidth away from users who have gained thereby. By this means, if a client's allocation is cut, that allocation can be recovered if conditions improve. This scheme provides that the server will be optimally used and maximally efficient.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 demonstrates schematically the Internet, containing a number of separate service providers.

FIG. 2 demonstrates a block diagram of a server on which an exemplary embodiment of the invention can be implemented.

FIG. 3 demonstrates the allocations of bandwidth by a server to a number of clients over several iterations of the inventive method according to an exemplary embodiment.

FIG. 4 demonstrates the changing bandwidth allocated to and used by a number of users in an exemplary embodiment of the invention.

### DETAILED DESCRIPTION OF THE PREFERRED EMBODIMENT

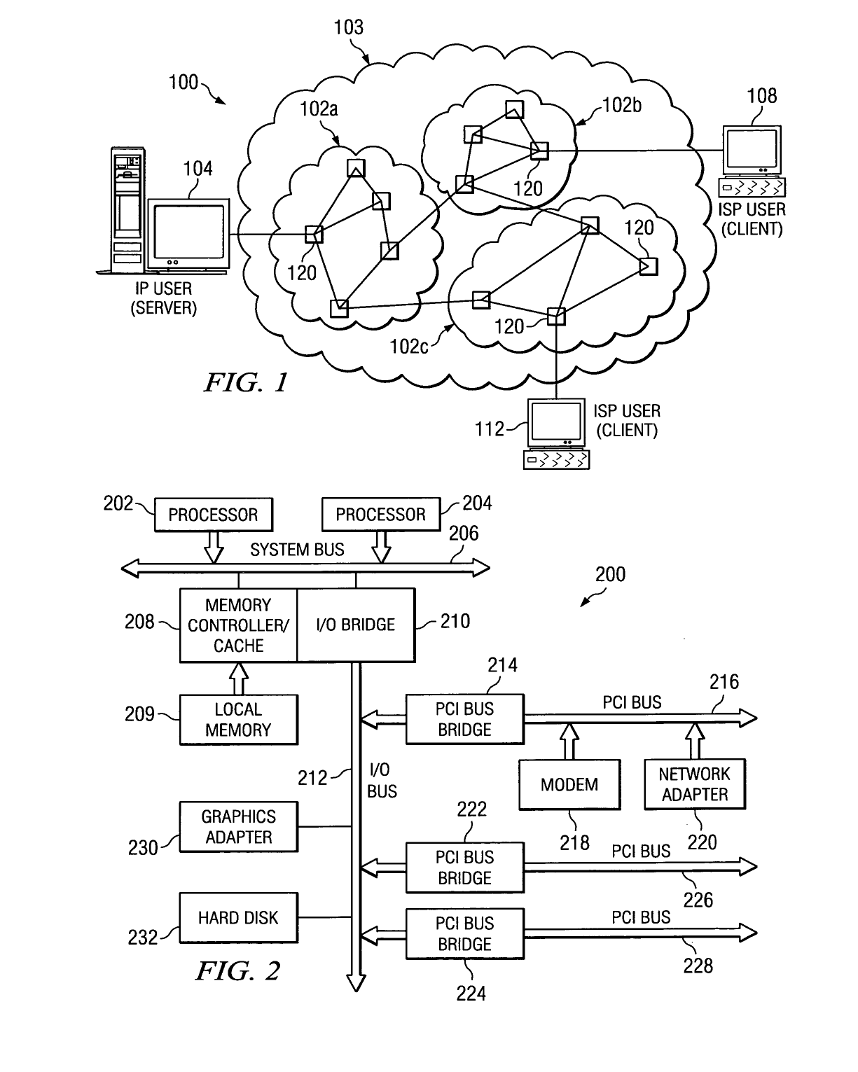

The invention will now be explained in accordance with the figures in an exemplary embodiment. FIG. 1 illustrates the collection of networks and interconnections known as the Internet 100. Within the Internet are a number of Internet Service Providers (ISPs) 102. Each of these ISPs 102a, 102b, 102c maintains its own domain of connected routers 120, as well as connections to other ISPs. Although there will be many users attached to the Internet, only three are shown. User 104 is a server that is attached to ISP 120A; both user 106, who is attached to ISP 102C, and user 108, who is attached to ISP 102B, are clients seeking to retrieve information provided by the server of user 104.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

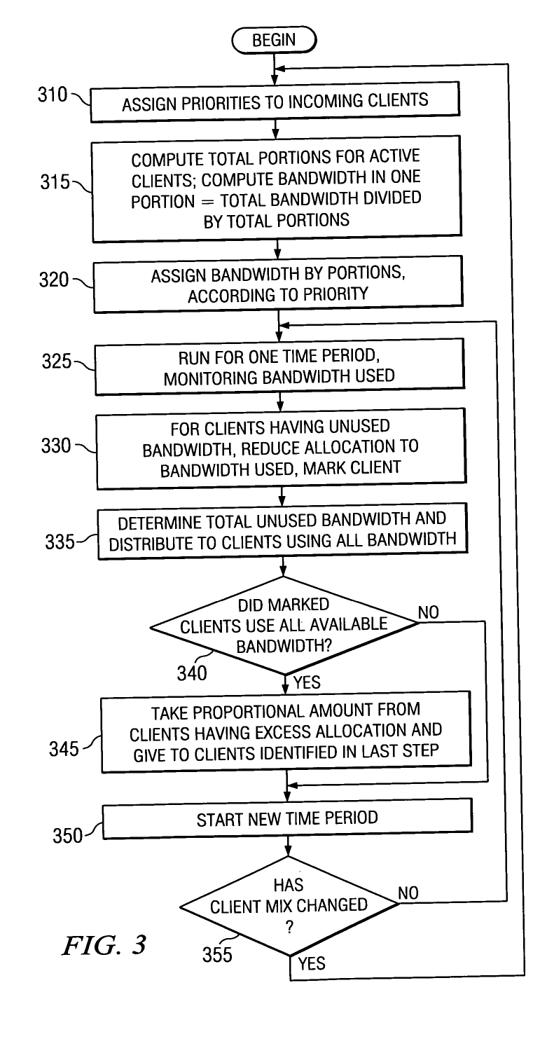

A server operating according to the invention will implement the steps shown in FIG. 3. First, as new clients come in, they are assigned a priority (step 310). These priorities can be assigned in any imaginable manner. The most common ways that would determine client priority are User Login and IP Address/Net mask. In an exemplary embodiment, root user login clients are assigned a priority 1, clients from internal networks (for example, those with IP addresses in the range 192.168.0.0 to 192.168.255.255) would be a priority 2, and all other clients would be priority 3.

Once the priority is known, bandwidth can be assigned to each client to guarantee that clients of the same rank all receive equal amounts of potential bandwidth, and that clients of higher priorities receive larger amounts. These assignments would be re-calculated every time a new client logs on, an old client logs off, or a client's priority is altered.

Preferably, distribution is figured in portions. For example, priority 1 clients receive six portions, priority 2 clients receive two portions, and priority 3 clients receive one portion. The actual distribution can be figured by adding the portions for all of the active clients. The number of portions to be assigned is divided into the total available bandwidth to determine the bandwidth that forms one portion (step 315). The actual bandwidth in one portion will vary, depending on the load on the server, but the various clients will be assigned in the ration of 6:2:1 (step 320).

After the bandwidth assignment has been made, the server will monitor and adjust the effective rate at which the server is sending information to each client. This monitoring can be accomplished by keeping a count of how many bytes have been sent to the client in a given time period (step 325). If the circuit between the server and a client is heavily loaded, the server will not be able to transmit to that client as often as it has allocated for. In this instance, the bandwidth allocated to that user will be reduced to the actual bandwidth used (step 330). The total unused bandwidth from all the users can be added to give an amount that can be reassigned to other users. This available bandwidth is then reassigned to users who are using all their bandwidth, in proportion to their priority (step 335). Thus, if one or more clients are unable to use all their bandwidth, clients who are using all their bandwidth can use additional bandwidth. Over time, this process will reduce the limits of all slow clients and increase faster clients' limits, ensuring that all available bandwidth is being used.

To ensure that a client does not permanently suffer for a temporary slowdown in their load, the optimized limits will be slowly adjusted to their original values, to allow clients that have had their bandwidth allocation reduced to grow back toward their original amount. First, clients that were marked are checked to be sure that at least one was using all available bandwidth. If at least one marked client used all their bandwidth, the bandwidth of those clients who are using more than their original allocation are reduced, while the amount by which they are reduced is given to the marked clients identified in the prior step (step 345). If no marked clients are using all their bandwidth, step 345 is skipped. Once these adjustments are made, the server clears the counters for the bytes sent and starts a new time period (step 350). If the client mix has changed (a client has been added, left, or its priority changed), the server will return to the first step of assign a priority to incoming clients. If the mix has not changed, the server goes to step 325 to run for another time period and monitor client transmissions. With every iteration, the file server adjusts to the dynamic conditions of the network and the existing client base, providing maximum efficiency.

In addition to the adjustments for unused bandwidth, individual priorities can be automatically adjusted for special circumstances, if desired. For example, if a client has been transferring from the file server for a very long time, it would be possible to lower that client's priority. Likewise, if a client is accessing an important file that is needed quickly, that client's priority can be raised while transferring that file.

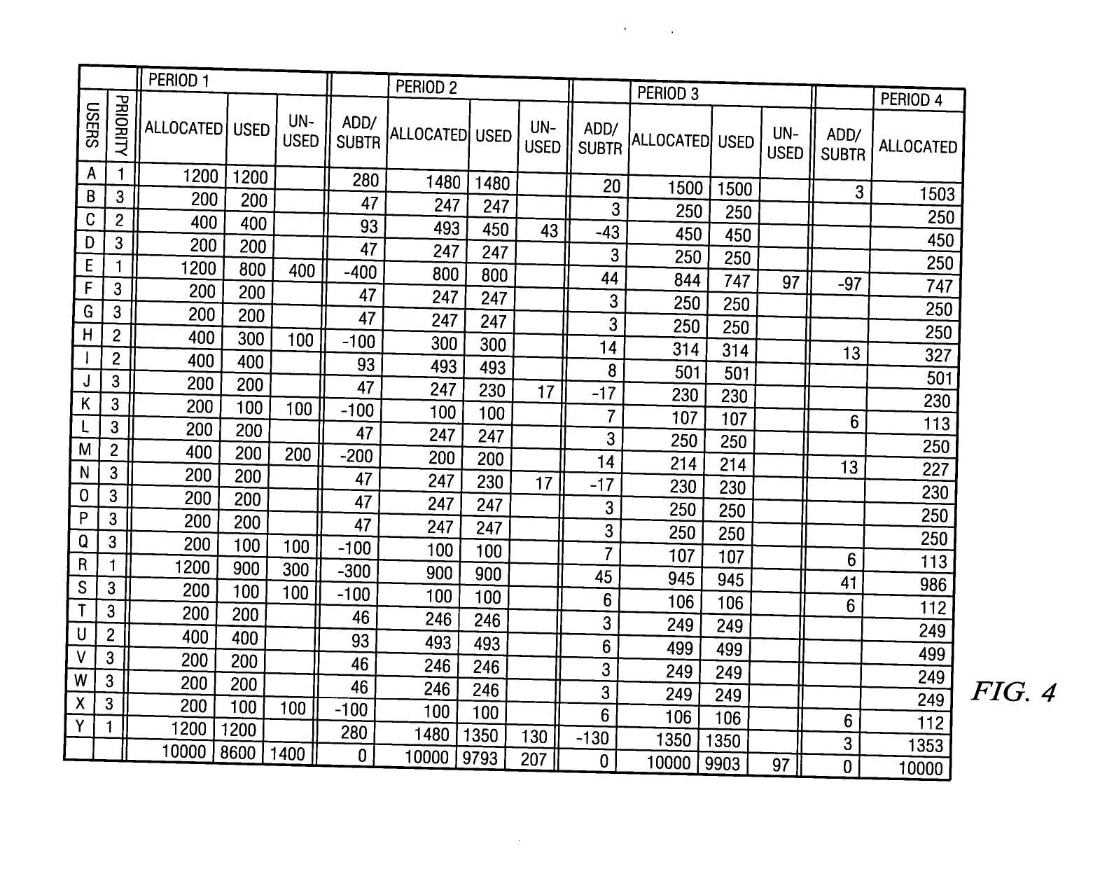

In FIG. 4, the bandwidth allocated to and used by a number of users is shown in an exemplary embodiment of the invention. In the first period, a new user Y has just been added and assigned a priority of 1. This server can transmit information at the rate of 10,000 packets in a given time period. At the end of that time period, the actual usage for each client will be evaluated and the bandwidth reallocated. As in the example mentioned above, a priority 3 user is assigned one portion of transmission time, a priority 2 user is assigned 2 portions, and a priority 1 user is assigned 6 portions of bandwidth. By calculating the portions assigned to each of the active users, the total portions is determined to be fifty (50). Therefore, each priority 3 user will initially receive a bandwidth allocation of 200 (10,000 divided by 50), each priority 2 user will receive an allocation of 400, and each priority 1 user will receive an allocation of 1200, as shown in the “Allocated” column of Period 1.

At the end of the first time period, the actual usage is checked. Although User E (a priority 1 user) received a bandwidth allocation of 1200, only 800 were actually used. Likewise, for User H, 300 of 400 units were used; for User K, 100 of 200 units were used; for User M, 200 of 400 units were used; for user Q, 100 of 200 units were used; for User R, 900 of 1200 units were used, for User S. 100 of 20 units were used; and for User X, 100 of 200 units were used. The unused portions of the allocated bandwidths total 1400 units. For each of these users who did not use their entire allocation, the unused amount of bandwidth is subtracted from that user's allocation and the user marked. Therefore, there are 1400 units of bandwidth that can be allocated to the remaining users. The group of users that will receive additional bandwidth contains two priority 1 users (6 portions each equals 12), three priority two users (2 portions each equals 6), and twelve priority three users (1 portion each equals 12), for a total of 30 receiving portions.

The 1400 units of bandwidth are divided by 30, giving a total of 46.67. Since a packet cannot be divided into fractions, the server will allocate additional bandwidth in increments of 47, 93, and 280, with minor adjustments made for the later entries in the table. Since the amount of bandwidth taken away from some users is the same as the amount of bandwidth given to other users, the total for this column is zero.

As a new period begins, the current allocation for each user is shown in the “Allocated” column of Period 2. At the end of this period, the bandwidth used is shown for each user. In this iteration, only a few users had unused bandwidth and these amounts were smaller than in Period 1. This period, the unused bandwidth is only 207. Again, for any user who did not use all their allocation (e.g., Users C, J, N, and Y), their allocation is reduced to the bandwidth actually used. This 207 units is distributed to the remaining users (40 portions) in amounts of 5, 10, and 31 (with occasional small adjustments to keep the totals correct). Additionally, eighteen users started this period with allocations greater than their initial allocation. These users will have a small amount of bandwidth taken away to redistribute to the users who started the period lower than initially assigned and who used all their bandwidth this period. Users A, B, D, F, G, I, L, O, P, and T-W will have small amounts taken away (2 units from priority 3, 4 units from priority 2, 12 units from priority 1 for a total of 38 units) and redistributed proportionately to users E, H, K, M, Q-S, and X. In this example, User A, by virtue of its high priority, gained 32 units from users who did not use all their bandwidth, but then lost 12 because it was operating at above its original allocation, giving it a total change of 20 units. Other users can be similarly calculated.

The third period then runs and at the end of this period, the bandwidths used are as shown, with only one user, User E, having unused bandwidth. In this iteration, User E's bandwidth is reduced and 97 units are redistributed to the other users (44 portions) in increments of 2, 4, and 15. Again the users who began this period operating above their original allocation will have small amounts taken away (total of 60 units) and redistributed proportionately to users operating below their original allocation (total of 14 portions) in units of 4, 9, and 26. Note that for many users, the amount gained from User E was the same as they lost for being above their original allocation, so that their allocation neither grew nor shrank.

The above example is intended for illustration only and is not to be considered limiting in any way. For instance, the amounts by which users operating outside their original limits are adjusted each period can be set for each installation. Also easily adjustable are the amount of time in each period, the proportions between the different priorities, etc.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of transmitting information on a network, comprising:
sending information to a plurality of clients across said network, wherein each active client is allocated a corresponding initial amount of bandwidth for transfer of information, according to a priority assigned to said client;
when a first active client is operating with a respective allocation and a portion of said first client's respective allocation is not used in a given time period, reducing said first client's respective allocation by the amount of said portion and redistributing said portion of bandwidth to other active clients, each of said other active clients having used all of a respective allocation of bandwidth;
wherein said method seeks to utilize all portions of available bandwidth.

2. The method of claim 1, wherein said portion of bandwidth will be redistributed according to a same system of priority as the initial allocation of bandwidth.

3. The method of claim 1, wherein an initial amount of bandwidth allocated to each active user is recalculated each time a user changes status from active to inactive or inactive to active or a user's priority changes.

4. The method of claim 1, further comprising taking a small amount of bandwidth away from a first group of users that are operating with a respective amount of bandwidth greater than a respective initial allocation and redistributing said small amount of bandwidth to ones of a second group of users that are both operating with a respective allocation of bandwidth less than a respective initial allocation and are using all of said respective allocation.

5. The method of claim 1, wherein said network is the Internet.

6. The method of claim 1, wherein respective initial amounts of bandwidth are allocated as a calculated percentage of total bandwidth.

7. The method of claim 6, wherein each priority three client receives an initial allocation of one part, each priority two client receives an initial allocation of two parts, and each priority one client receives an initial allocation of six parts.

8. A server for transmitting information on a network, said server comprising:
an input device for receiving requests on said network from a plurality of active users;
an output device for providing information through said network to said plurality of active users;
a processor connected to said input device and to said output device to process requests and provide information; and
an allocation program executed by said processor, said allocation program being connected to provide allocations of bandwidth for sending information successively to ones of said plurality of active users, said allocation program comprising:
first instructions for allocating a first portion of bandwidth to ones of said active users having a first priority and for allocating a second portion of bandwidth to ones of said active users having a second priority; and
second instructions for determining a first amount of bandwidth of a first user's allocation that has not been used, reducing said first user's allocation by said first amount, and redistributing said first amount of bandwidth to other active clients, each of said other active clients having used all of a respective allocation of bandwidth.

9. The server of claim 8, wherein said second instructions redistribute said first amount of bandwidth according to a same system of priority as said first instructions.

10. The server of claim 8, wherein said first instruction are performed each time one of the following events occurs: a new user requires an allocation, an existing user no longer requires an allocation, or a user's priority is changed.

11. The method of claim 8, further comprising third instructions for taking a respective amount of bandwidth away from a first group of users, each of said first group of users operating with an amount of bandwidth greater than allocated in said first instructions and redistributing said respective amount of bandwidth to a second group of users, each of said second group of users both operating with a respective allocation of bandwidth less than a respective initial allocation and using all of said respective allocation.

12. The method of claim 8, where said network is the Internet.

13. The method of claim 8, wherein respective initial amounts of bandwidth are allocated as a calculated percentage of total bandwidth.

14. The method of claim 13, wherein each priority three client receives an initial allocation of one part, each priority two client receives an initial allocation of two parts, and each priority one client receives an initial allocation of six parts.

15. A computer program product on a computer readable medium, said computer program product comprising:
first instructions for allocating a first percentage of bandwidth to ones of said active users having a first priority and for allocating a second percentage of bandwidth to ones of said active users having a second priority;
second instructions for determining a first amount of bandwidth of a first user's allocation that has not been used, reducing said first user's allocation by said first amount, and distributing said first amount of bandwidth to other active clients, each of said other active clients having used all of a respective allocation of bandwidth.

16. The computer program product of claim 15, wherein said second instructions redistribute said first amount of bandwidth according to a same system of priority as in said first instructions.

17. The computer program product of claim 15, wherein said first instruction are performed each time one of the following events occurs: a new user requires an allocation, an existing user no longer requires an allocation, or a user's priority is changed.

18. The method of claim 15, further comprising third instructions for taking a respective amount of bandwidth away from a first group of users, each of said first group of users operating with an amount of bandwidth greater than allocated in said first instructions and distributing said respective amount of bandwidth to a second group of users, each of said second group of users operating with an amount of bandwidth less than allocated in said first instructions.

19. The method of claim 15, where said network is the Internet.

20. The method of claim 15, wherein said first instructions allocate respective initial amounts of bandwidth as a calculated percentage of total bandwidth.

21. The method of claim 20, wherein each priority three client receives an initial allocation of one part, each priority two client receives an initial allocation of two parts, and each priority one client receives an initial allocation of six parts.
